(19) United States
(12) Patent Application Publication
(10) Pub. No.: US 2002/0085667 A1
(43) Pub. Date: Jul. 4, 2002

(54) Method and apparatus for automatic offset correction in digital flouroscopic X-ray imaging systems

(76) Inventor: Christopher Miller, Delafield, WI (US)

Correspondence Address: Dean D. Small, McAndrews, Held & Malloy, Ltd., 34th Floor, 500 West Madison Street, Chicago, IL, 60661, US

(21) Appl. No.: 09/752,790

(22) Filed: Dec. 28, 2000

(51) Int. Cl. G01N 23/223

(52) U.S. Cl. 378/48; 378/42

(57) ABSTRACT

A preferred embodiment of the present invention provides a method and apparatus for automatic offset correction in digital fluoroscopic x-ray imaging systems. In a preferred embodiment, the method comprises exposing a detector to an energy source to obtain image exposure data from an exposed detector section within the detector. The method further comprises obtaining reference data from at least one reference area that is unaffected by the energy source. The method further comprises generating a diagnostic image based on a relation between the image exposure data and the reference data. In a preferred embodiment, the apparatus comprises an energy source and a detector. The detector comprises an exposed detector section. The detector includes at least one reference area. The at least one reference area is unaffected by the energy source.

### BACKGROUND OF THE INVENTION

The preferred embodiments of the present invention generally relate to digital fluoroscopic x-ray imaging systems, and in particular relate to a method and apparatus for automatic offset correction in digital fluoroscopic x-ray imaging systems.

X-ray imaging has long been an accepted medical diagnostic tool. X-ray imaging systems are commonly used to capture, as examples, thoracic, cervical, spinal, cranial, and abdominal images that often include information necessary for a doctor to make an accurate diagnosis. X-ray imaging systems typically include an x-ray source and an x-ray sensor. When having a thoracic x-ray image taken, for example, a patient stands with his or her chest against the x-ray sensor as an x-ray technologist positions the x-ray sensor and the x-ray source at an appropriate height. X-rays produced by the source travel through the patient's chest, and the x-ray sensor then detects the x-ray energy generated by the source and attenuated to various degrees by different parts of the body. An associated control system obtains the detected x-ray energy from the x-ray sensor and prepares a corresponding diagnostic image on a display.

X-ray images may be used for many purposes. For instance, internal defects in a target object may be detected. Additionally, changes in internal structure or alignment may be determined. Furthermore, the image may show the presence or absence of objects in the target. The information gained from x-ray imaging has applications in many fields, including medicine and manufacturing.

X-ray systems may be fluoroscopic x-ray systems. Fluoroscopy is a method of diagnostic imaging that allows real-time imaging of a patient's internal motion. Fluoroscopy is employed with a contrast agent to observe motion within a patient. A contrast agent, such as barium, may be swallowed or injected into a blood vessel or organ (such as an intestine). The contrast agent increases the absorption of x-rays and provides increased contrast in an x-ray image. Fluoroscopy may also be used to guide instruments inside the body of a patient during a medical procedure. Fluoroscopic images may assist in maneuvering instruments within the patient.

In x-ray radiography, a patient is exposed to short, higher dosage x-ray emissions to produce discrete images. In order to observe patient motion, many images are obtained in x-ray fluoroscopy. The images may be obtained rapidly, and may also be acquired over an extended period of time. Some current x-ray fluoroscopy systems acquire many x-ray images per second over a several-minute interval. Due to the increased number of exposures, the x-ray dosage in fluoroscopy is reduced. A reduction in x-ray dosage may reduce the quality of the resulting image.

A lower x-ray dosage may result in a lower number of x-rays produced by the x-ray source. Fluoroscopic x-ray detectors are sensitive to the low x-ray dosage. Fluoroscopic x-ray systems may employ image intensifier tubes for x-ray detection (See FIG. 1). X-rays traveling from the source through the patient reach a phosphor screen. The phosphor screen emits light in response to x-ray contact. The light travels to a photoelectric layer. The photoelectric layer emits electrons in response to light absorbed. The emitted electrons are accelerated through the Image Intensifier tube by high potentials and focused by electrodes. The high speed, focused electrons contact an output phosphor screen. The output phosphor screen emits light in response to the absorbed electrons. A video camera records the light emitted from the output phosphor screen. The video camera recording may be displayed on a monitor. Alternatively, video cameras have been replaced by charge coupled devices (CCDs).

Digital fluoroscopic x-ray systems may also employ amorphous silicon flat panel detectors. Amorphous silicon is a type of silicon that is not crystalline in structure. Image pixels are formed from amorphous silicon photodiodes connected to switches on the flat panel. A scintillator is placed in front of the flat panel detector. The scintillator receives x-rays from an x-ray source and emits light in response to the x-rays absorbed. The light activates the photodiodes in the amorphous silicon flat panel detector. Readout electronics obtain pixel data from the photodiodes through data lines (columns) and scan lines (rows). Images may be formed from the pixel data. Images may be displayed in real time. Flat panel detectors may offer more detailed images than image intensifiers. Flat panel detectors may allow faster image acquisition than image intensifiers.

In any imaging system, x-ray or otherwise, image quality is important. In this regard, x-ray imaging systems that use digital or solid state image detectors (“digital x-ray systems”) experience certain electrical phenomena that cause imaging difficulties. Difficulties in a digital x-ray image could include image artifacts, “ghost images,” or distortions in the digital x-ray image. Imaging difficulties may be caused by effects such as electronic current leakage from imaging system circuitry, x-ray detector, and the like. During digital fluoroscopic x-ray system calibration, a “dark” image may be acquired to adjust the image intensity offset. A “dark” image is a reading taken of the image intensifier, CCD, flat panel display, and the like without x-ray exposure. For example, a “dark” image simply gathers data without activating the fluoroscopic image intensifier tube. By way of example, one electrical phenomena is that, over time, electronic circuits experience drift in their baseline response and changes in their gain response. Changes in baseline response and gain cause an “offset” or change in the electrical response of the detector for the signal produced based on a given x-ray count. For example, a new detector may produce a 5 volt signal when an x-ray count of 5000 RADs is detected. However, as time passes, the baseline response may increase 5 volts and thus the detector may produce a 10 volt signal when the same 5000 RAD count is detected. A “dark” image may determine the offset produced by the detector and x-ray system since it will capture the baseline shift. By subtracting the “dark” image pixel values from the actual “exposed” x-ray image pixel values of a desired object, the offset effects may theoretically be eliminated. Conventional systems typically acquire offset readings in between fluoroscopic x-ray imaging exposures.

Heretofore, dark image data has not been obtainable during fluoroscopic x-ray exposure. Also, conventional systems have been unable, in digital fluoroscopic x-ray systems, to correct variation in offset data (i.e., change in baseline response from phenomena such as electronic leakage effects and gain variation) during digital fluoroscopic x-ray system operation. The offset of the system may vary considerably over the period of the exposure if the radiologist continues to use the fluoro mode for an extended period of time. The detector and electronics are very sensitive to temperatures, and to a certain degree, time. Thus, small temperature changes that occur over time may cause changes in the displayed image, especially the dark portions of the image. Additionally, some long-term electronic settling conditions, such as electronic settling conditions caused by interface charges that are trapped within amorphous silicon structures of a detector panel, may cause changes in the displayed image. Conventional systems have not satisfactorily corrected for these changes.

Thus, a need exists for a method and apparatus that is capable of automatic offset correction of a digital fluoroscopic x-ray imaging system during operation of an x-ray exposure.

### BRIEF SUMMARY OF THE INVENTION

A preferred embodiment of the present invention provides a method and apparatus for automatic offset correction of a digital fluoroscopic x-ray imaging system during operation of an x-ray exposure. The apparatus comprises an energy source and a detector. The detector comprises an exposed detector section. The detector includes at least one reference area. The at least one reference area is unaffected by the energy source. The method comprises exposing a detector to an energy source to obtain image exposure data from an exposed detector section within the detector. The method further comprises obtaining reference data from at least one reference area that is unaffected by the energy source. In a preferred embodiment, the reference data comprises dark image characteristics, such as diode leakage, discharge of interface trap charges, and the like. The method further comprises generating a medical diagnostic image based on a relation between the image exposure data and the reference data. In a preferred embodiment, the relation comprises calibrating the image exposure data with the reference data. The relation may comprise subtracting the reference data from the image exposure data. In a preferred embodiment, the method and apparatus operate in real time during an x-ray exposure.

### BRIEF DESCRIPTION OF THE DRAWINGS

FIG. 1 illustrates an image intensifier used with a fluoroscopic imaging system.

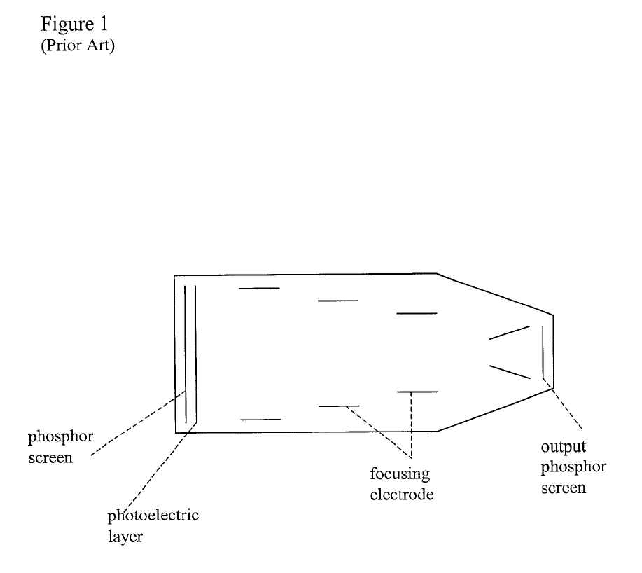

FIG. 2 illustrates a preferred embodiment of a digital fluoroscopic imaging system.

FIG. 3 illustrates a preferred embodiment of a flat panel detector.

FIG. 4 depicts a preferred embodiment of a flat panel detector with reference areas.

FIG. 5 illustrates a method for automatic offset correction in digital fluoroscopic imaging systems.

### DETAILED DESCRIPTION OF THE INVENTION

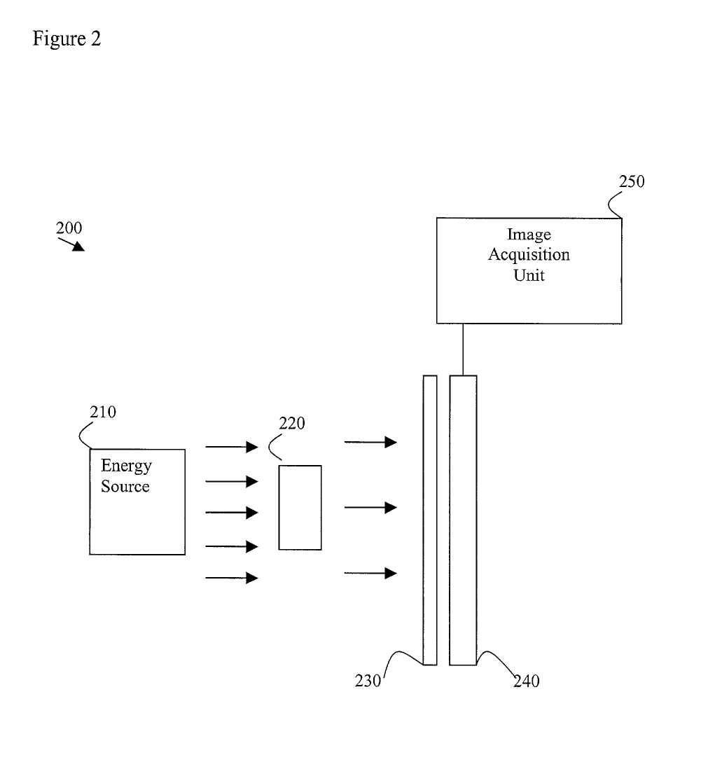

FIG. 2 illustrates a preferred embodiment of a digital fluoroscopic imaging system 200. The digital fluoroscopic diagnostic imaging system 200 comprises an energy source 210, a target 220, a scintillator 230, a detector 240, and an image acquisition unit 250. In a preferred embodiment, the energy source 210 comprises an x-ray energy source 210, while the target 220 comprises a patient 220. In a preferred embodiment, the scintillator 230 comprises a screen 230 in front of the detector 240. In a preferred embodiment, the detector 240 comprises an amorphous silicon flat panel detector 240, while the flat panel detector 240 comprises an Apollo amorphous silicon flat panel detector 240. The flat panel detector 240 may comprise thin-film amorphous silicon photodiodes connected to switches on the flat panel.

The patient 220 is positioned between the x-ray source 210 and the scintillator 230. The x-ray energy source 210 generates x-rays. The x-rays pass through the patient 220. Preferably, a contrast agent (such as barium and the like) is injected into the patient 220 to absorb x-rays in blood vessels and increase contrast in the resulting x-ray image. The remaining x-rays strike the scintillator 230. The scintillator 230 emits light in response to x-rays absorbed. Light emitted by the scintillator 230 activates the photodiodes in the flat panel detector 240. Readout circuitry transmits the data from the flat panel detector 240 to the image acquisition unit 250. The image acquisition unit 250 may display the image. In a preferred embodiment, the image acquisition unit 250 may display x-ray images on video. Alternatively, the image acquisition unit 250 may display x-ray images on a monitor. Alternatively, the image acquisition unit 250 may store x-ray images in memory. The x-ray images may be examined on a computer.

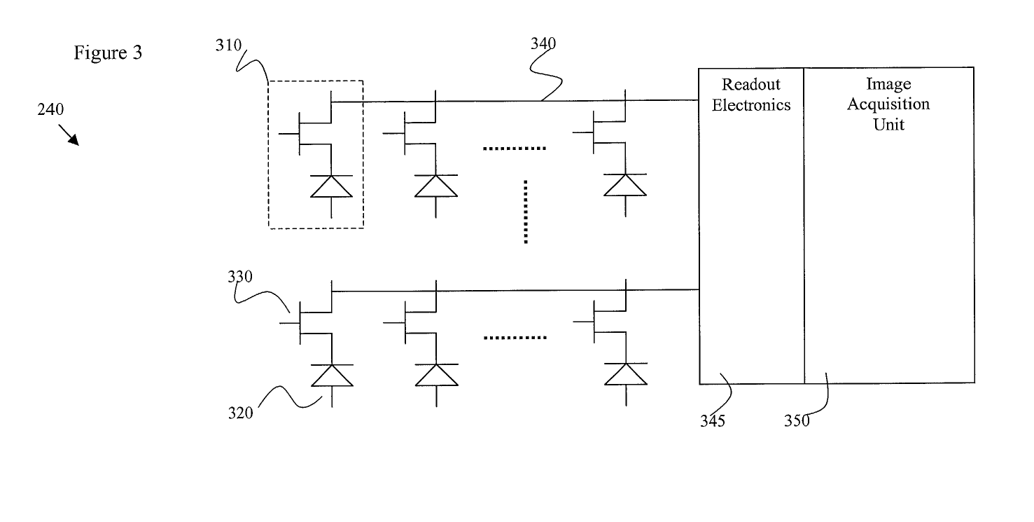

FIG. 3 illustrates a preferred embodiment of a detector 240. The detector 240 comprises cells 310 connected by data lines 340 to readout electronics 345 and image acquisition unit 350. The cells 310 comprise photodiodes 320 connected to FET (Field Effect Transistor) switches 330. When light strikes the photodiodes 320, the photodiodes 320 discharge in proportion to the light exposure. When the FET switches 320 are closed, the photodiodes 320 recharge, and a measure of the light (and thus the x-ray) exposure may be obtained via the data lines 340 and readout electronics 345.

Offset effects from the electronics of the digital fluoroscopic imaging system may distort or introduce artifacts into the resulting image. In an attempt to counteract the effects of the offset, a “dark” image may be obtained from the imaging system. In a “dark” image, data is taken when the x-ray source 210 is not emitting x-rays. The dark image data includes the offset from the digital fluoroscopic imaging system. A dark image may be obtained prior to or following a fluoroscopic image exposure. However, dark image offset data may not be obtained during fluoroscopic imaging.

In a preferred embodiment, the digital fluoroscopic imaging system may be used for long periods of continuous examination. For example, fluoroscopic x-ray images may be used to guide a doctor during surgery. The offset effects induced in the system may vary over the period of exposure. Offset changes may occur due to temperature changes, electronic leakage current, discharge of interface trap charges, and the like. In a preferred embodiment, offset readings may be obtained during fluoroscopic exposure. Offset readings are obtained simultaneously along with image data and need not be acquired as an additional dark image. Reference areas on a detector 240 may be used to obtain offset data during fluoroscopic exposure (fluoro mode).

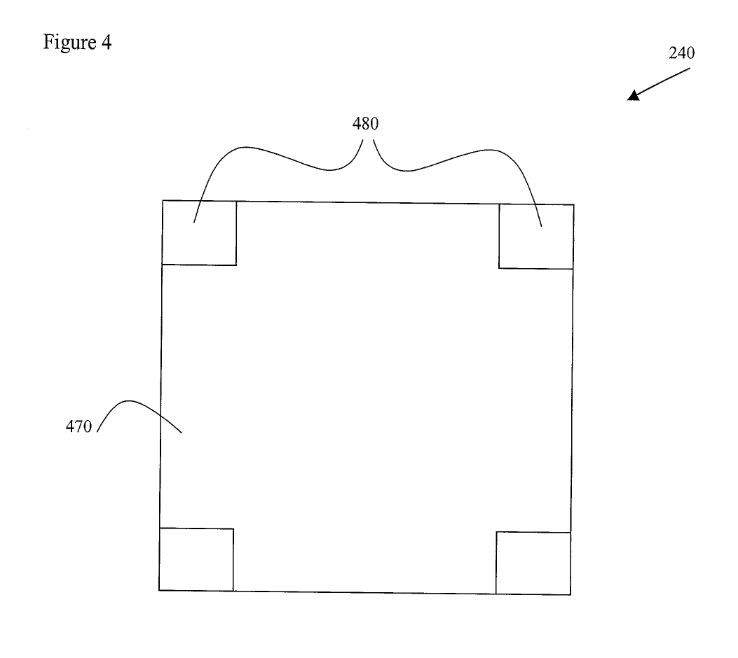

FIG. 4 depicts a preferred embodiment of a flat panel detector 240. The flat panel detector 240 comprises an exposed detector section 470 and at least one reference area 480. The reference areas 480 serve as a zero reference signal during acquisition of the fluoroscopic image. The reference areas 480 are masked out so that they do not respond to x-ray radiation. An x-ray blocking material is positioned over the reference areas 480 to ensure that no x-rays (or scintillation light representative of x-rays) impinge on the reference areas 480. In a preferred embodiment, the reference areas 480 are blocked with lead. Data obtained from the reference areas 480 represents offset data identifying changes in the electrical response of the detector due to temperature changes, electronic leakage current, discharge of interface trap charges, and the like. The offset data obtained simultaneously with x-ray exposure data is compared to system reference data (for example, data obtained from the dark image) and the relation (for example, the difference) there between is used to compensate for offsets in the exposure data.

In a preferred embodiment, the reference areas 480 are located at the comers of the flat panel detector 240. Alternatively, the reference areas 480 may extend along the sides of the flat panel detector 240. The image acquisition unit 250 may obtain image exposure data from the exposed detector section 470 of the flat panel detector 240 and offset reference data from the reference areas 480. The image acquisition unit 250 may adjust the image exposure data based on the updated reference data to produce a diagnostic image. For example, the image exposure data contains offset effects from electronic leakage current, temperature changes, discharge of interface traps charges, and the like, and the updated reference data reflects those offset effects. The reference data values may be subtracted from the image exposure data values to eliminate the offset effects reflected in the reference data. As another example, image exposure data may be adjusted by a ratio of the updated reference data to the image exposure data.

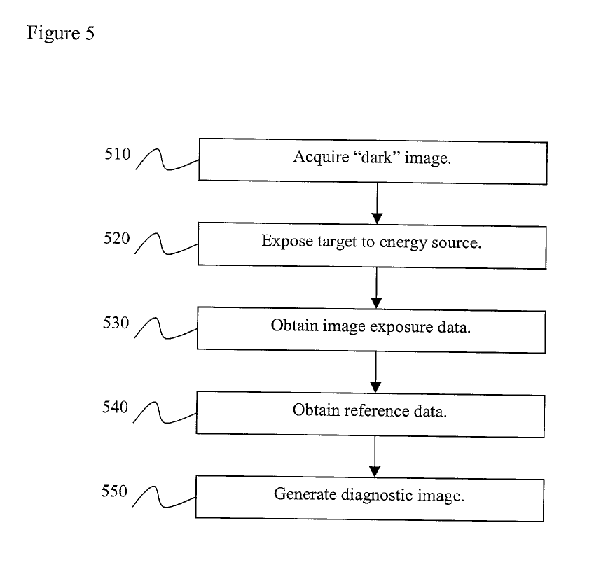

FIG. 5 illustrates a method for automatic offset correction in digital fluoroscopic imaging systems. In step 510, the digital fluoroscopic imaging system 200 acquires a dark image. The dark image is obtained with no x-ray ray exposure. Dark image offset data may be obtained form the dark image. The dark image offset data may provide a baseline for adjusting image data obtained from fluoroscopic exposures.

In step 520, the target 220 is exposed to an energy source 210. In a preferred embodiment, the target 220 is exposed to an x-ray energy source 210. The x-rays travel through the target 220 and impinge upon the scintillator 230. The scintillator 230 emits light in response to the x-rays absorbed by the scintillator 230. The light emitted by the scintillator 230 strikes the detector 240. In step 530, image exposure data is obtained from the exposed detector section 470 of the flat panel detector 240 not covered by reference areas 480. The image exposure data is used to construct the resulting diagnostic image. In a preferred embodiment, readout electronics 345 obtain image exposure data from the cells 310 of the detector 240 via data lines 340. The readout electronics 345 transmit the image exposure data to the image acquisition unit 250.

In step 540, reference data is obtained from at least one reference area 480 on the detector 240. The reference data may provide information on offset effects, such as electronic leakage, discharge of interface trap charges, and the like. Reference data may be used to update the initial offset data obtained from the offset data. Preferably, the reference areas 480 are comprised of specific areas of the detector which are shielded against x-rays by lead. In a preferred embodiment, the reference areas 480 are located in the comers of the detector 240. In an alternative embodiment, the reference areas 480 are located along the sides of the detector 240.

In step 550, a diagnostic image is generated. The diagnostic image is generated based on the image exposure data obtained from the detector 240. The image exposure data is corrected using dark image offset data obtained from the dark image and reference data obtained from detector 240 reference areas. The dark image and reference offset data correct for image artifacts and disruptions caused by the imaging system electronics.

Thus, the present invention provides a fairly simple solution to what has become a serious image quality issue for digital fluoroscopic x-ray systems. The method and apparatus for automatic offset correcting in digital fluoroscopic x-ray systems may improve the design of new fluoroscopic diagnostic imaging systems and may enhance the image quality of existing fluoroscopic diagnostic imaging systems through offset correction. The present invention may be easily implemented and does not necessarily require a change to existing hardware beyond the insertion of reference areas in the detector.

Optionally, alternative preferred embodiments of the present invention may be implemented using a scanning camera or CDD in the detector in place of the flat panel detector 240.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for generating a diagnostic image acquired by a detector in a fluoroscopic diagnostic imaging system, said method comprising:
obtaining an exposure image of a target by exposing at least a portion of a detector to an energy source, said exposure image including an exposed detector area representative of said target and at least one reference area that is unaffected by said energy source;
obtaining reference data from said at least one reference area in said exposure image and target exposure data from at least said exposed detector area of said exposure image; and
generating a diagnostic image based on said image exposure data and said reference data.

2. The method of claim 1 wherein said energy source comprises an x-ray energy source.

3. The method of claim 1 wherein said at least one reference area comprises at least one reference area located in at least one comer of said exposed detector area.

4. The method of claim 1 wherein said at least one reference area comprises at least one reference area extending along at least one side of said exposed detector area.

5. The method of claim 1 wherein said at least one reference area is comprised of an area of the detector which is shielded by lead.

6. The method of claim 1 wherein said generating step further comprises subtracting said reference data from said target exposure data.

7. The method of claim 1 wherein said generating step further comprises calibrating said target exposure data based on said reference data to produce said diagnostic image.

8. The method of claim 1 wherein said reference data is representative of dark image characteristics.

9. The method of claim 1 wherein said reference data is representative of electronic leakage current.

10. The method of claim 1 wherein said reference data is representative of discharge of interface trap charges.

11. The method of claim 1, further comprising masking a portion of said detector from said energy source to form said at least one reference area in said exposure image.

12. A fluoroscopic imaging system, said system comprising:
an energy source;
a detector having an exposed detector section exposed to said energy source and at least one reference area that is unaffected by said energy source, said detector obtaining exposure images of a target;
an image acquisition unit that obtains reference data from said exposure image corresponding to said at least one reference area and target exposure data from said exposure image corresponding to said exposed detector section; and
a display displaying diagnostic images based on said target exposure data and said reference data.

13. The system of claim 12 wherein said energy source comprises an x-ray energy source.

14. The system of claim 12 wherein said at least one reference area comprises at least one reference are located in at least one comer of said exposed detector section.

15. The system of claim 12 wherein said at least one reference area comprises at least one reference area extending along at least one side of said exposed detector section.

16. The system of claim 12 wherein said at least one reference area is comprised of an area of the detector which is shielded by lead.

17. The system of claim 12 wherein said image acquisition unit measures dark image characteristics based on said reference data.

18. The system of claim 12 wherein said image acquisition unit measures electronic leakage current based on said reference data.

19. The system of claim 12 wherein said image acquisition unit measures discharge of interface trap charges based on said reference data.

20. The system of claim 12, further comprising a mask located on said detector over said at least one reference area to block said energy source.

21. A method for fluoroscopic diagnostic imaging, said method comprising:
obtaining an exposure image of a target by exposing at least a portion of a detector to an energy source, said exposure image including a exposed detector area representative of said target and at least one reference area that is unaffected by the energy source;
obtaining reference data from said at least one reference area in said exposure image and target exposure data from at least said exposed detector area of said exposure image;
generating a diagnostic image based on said target exposure data and said reference data; and
displaying said diagnostic image.

22. The method of claim 21 wherein said displaying step further comprises displaying on a video display.

23. The method of claim 21 wherein said displaying step further comprises displaying on a flat panel.

24. The method of claim 21 wherein said at least one reference area comprises at least one reference area located in at least one comer of said exposed detector area.

25. The method of claim 21 wherein said at least one reference area comprises at least one reference area extending along at least one side of said exposed detector area.

26. The method of claim 21 wherein said reference data is representative of dark image characteristics.
